(19) United States
(12) Patent Application Publication
(10) Pub. No.: US 2020/0327116 A1
(43) Pub. Date: Oct. 15, 2020

(54) SYSTEMS AND METHODS FOR DOCUMENT AUTOMATION

(71) Applicant: LYCONOS, INC., Boulder, CO (US)

(72) Inventors: David A. PERLICK, Boulder, CO (US); Satchel E. SPENCER, Boulder, CO (US); Alexander Hunter TRUJILLO, Denver, CO (US)

(73) Assignee: LYCONOS, INC., Boulder, CO (US)

(21) Appl. No.: 16/753,505

(22) PCT Filed: Oct. 2, 2018
(86) PCT No.: PCT/US18/53940

§ 371 Date: Apr. 3, 2020

Related U.S. Application Data
(60) Provisional application No. 62/567,619, filed on Oct. 3, 2017.

(51) Int. Cl. G06F 16/23; G06F 16/25; G06F 16/93; G06F 40/186; G06F 40/174

(52) U.S. Cl. CPC G06F 16/2379; G06F 16/252; G06F 40/174; G06F 40/186; G06F 16/93

(57) ABSTRACT

A method for document automation where the structured data that determines the content of the document(s) is stored within the metadata of the document(s), the method including obtaining at least one value to be populated into at least one field location in a document, storing each value with a unique identifier in metadata associated with the at least one document, wherein each value with its associated unique identifier is an attribute, and populating the at least one field location in the document with the at least one value.

### FIELD

Various embodiments of the present developments provide systems and methods for document automation, and more particularly for a document automation system that can include a document metadata filesystem database and/or that enables concurrent editing of structured data (e.g., fields) alongside unstructured data (e.g., document text), and graph-like access of data in the document metadata filesystem database.

### BACKGROUND

Document generation is critical to many complex tasks and can require entering and re-entering the same and related information many times, often in multiple documents. For example, a user might be required to maintain a set of forms that are reused many times, with different information to be entered into those forms. In a particular project a user is required to manually enter values into field locations within the one or more forms. However, the text of these forms often requires customization for each use. Traditional document automation systems gather the required information for a chosen form and produce a static document. If changes are needed in the values, the values can be modified manually, or the documents can be regenerated by the document automation system, which traditionally requires discarding text customizations. Therefore, if values need to be modified, the text customizations in the document will not appear in the original form, and must be manually added. Furthermore, because the output is a static document, any changes to the values in the custom document must be manually added. Furthermore, such a document automation system gathers the required information for a chosen form or set of forms and can store the information in a traditional database, which is not integrated with the forms. Traditional document automation systems are also cumbersome to share, store and transmit, requiring that a database be handled separately from documents and templates. A need exists for improved document automation systems which address one or more of these and other issues.

### SUMMARY

Various embodiments of the present developments provide systems and methods for document automation, including a document automation system that can include a document metadata filesystem database and/or that can enable concurrent editing of structured data (e.g., fields) alongside unstructured data (e.g., document text), and graph-like access of data in the document metadata filesystem database.

This summary provides only a general outline of some embodiments hereof. Additional embodiments are disclosed in the following detailed description, the appended claims and the accompanying drawings. Other features of embodiments of the present developments will be apparent from the accompanying drawings and from the detailed description that follows.

### BRIEF DESCRIPTION OF THE FIGURES

A further understanding of the various embodiments may be realized by reference to the figures which are described in remaining portions of the specification. In the figures, like reference numerals may be used throughout several drawings to refer to similar components.

FIG. 1 depicts a block diagram of a document with field locations for which values can be retrieved from entity graphs using accessors in accordance with one or more embodiments;

FIG. 2 depicts a block diagram of a document automation application in accordance with one or more embodiments;

FIG. 3 depicts a block diagram of a document automation plugin in accordance with one or more embodiments;

FIG. 4 depicts a block diagram of data storage for a document metadata filesystem database in some embodiments of a document automation system;

FIG. 5 depicts a flow diagram of updates in a document automation system in accordance with one or more embodiments;

FIG. 6 depicts a flow diagram of a document automation system propagating state changes and the structure of state changes in accordance with one or more embodiments;

FIG. 7 depicts a flow diagram showing a method for document automation and storing a database in document metadata in accordance with one or more embodiments;

FIG. 8 depicts a screenshot of a document automation system application identifying projects being maintained in accordance with one or more embodiments;

FIG. 9 depicts a screenshot of a single project being maintained by a document automation system before data is entered in accordance with one or more embodiments;

FIG. 10 depicts a screenshot of a project being maintained by a document automation system with data entered for two entities, in this example with the entities being people, in accordance with one or more embodiments;

FIG. 11 depicts a screenshot of a project in a document automation system as a new entity is entered, with autocomplete providing access to data from existing entities in accordance with one or more embodiments;

FIG. 12 depicts a screenshot of a document automation system after a new entity has been entered in accordance with one or more embodiments;

FIG. 13 depicts a screenshot of a document in a word processor with field locations to be populated by a document automation system in accordance with one or more embodiments;

FIG. 14 depicts a screenshot of the document of FIG. 13 in a word processor with field locations populated by a document automation system in accordance with one or more embodiments;

FIG. 15 depicts a screenshot of adding a field location to a document in a word processor to be populated by a document automation system in accordance with one or more embodiments;

FIG. 16 depicts a screenshot of the document of FIG. 15 in a word processor with the new field location populated by a document automation system in accordance with one or more embodiments; and

FIG. 17 depicts a block diagram of a computer system that can be used for document automation using a document metadata filesystem database in accordance with one or more embodiments.

### DETAILED DESCRIPTION

Various embodiments of the present developments provide systems and methods for document automation, and more particularly for a document automation system that can include one or more of the following features: a document metadata filesystem database, concurrent editing of structured data (e.g., field locations and values) alongside unstructured data (e.g., document text), and graph-like access of data. Note that the term “database” does not imply a single or central repository of data. In some embodiments, structured data used in a document is stored in the document file as metadata. Where multiple documents are grouped in a project, the metadata of each document file can store the structured data of just that document or of every document in the project. In the former case in which the metadata of each document file stores the structured data of just that document, a document automation application can be provided to gather or assemble the structured data for a project from each of the documents in the project to compute an intermediate global state, used to keep structured data synchronized across all the documents in the project as the structured data is edited. Thus, the term “database” is used herein with reference to some embodiments to refer to a distributed database in which each document file stores its own database content as well as static document content.

In some embodiments, the document automation system disclosed herein integrates with a document editor and manages structured data to be embedded or inserted within one or more documents alongside unstructured data in the one or more documents. The structured data can include values that contain information to be placed at particular locations within the one or more documents in an updateable manner. The unstructured data in the one or more documents can be edited by a document editor alongside the structured data as the document automation system captures changes made to the structured data and propagates changes to the structured data to all locations where that structured data appears in the one or more documents. Thus structured data remains consistent and updateable throughout the one or more documents, and this can be achieved even while the unstructured data is edited by the document editor.

In some embodiments, the documents comprise text documents and the document editor comprises a text editor or word processor. As field locations (references to values in structured data) are placed in a document, the document automation system identifies the values of the field locations and propagates changes to those field locations in all places where they appear in a document or a group of documents. The document editor enables a user to edit and save the unstructured data or content of the documents. Values and field locations can be edited directly in the documents by the document editor or by the document automation system, with changes to the values being propagated to all their field locations in the document or group of documents by the document automation system. This allows structured data to be edited alongside or concurrently with unstructured data, and for the structured data to remain consistent and to remain structured, rather than being merged into the document as static unstructured data that can no longer be managed by the document automation system. As an example, a value might consist of a person's name, and the corresponding field location might be placed in a document in multiple locations or even in multiple documents. The document automation system detects changes made to the person's name and propagates each change to its corresponding field locations in the document or group of documents. The structured data (the values containing the person's name) remains updatable even as changes are made to the unstructured data or body of the document or documents, rather than being statically merged into the unstructured data.

Although the example above is applied to a text document with text values, the document automation system is not limited to this particular embodiment. The document automation system can apply to text documents, spreadsheets, HTML documents, image files, computer executable source code, audio, video, etc. The document automation system can manage structured text in a text document, cell values or other data in a spreadsheet, computer executable code to be inserted in the source code for a computer program, data or HTML codes to be inserted in an HTML document, images or portions of images to be inserted into an image file, videos or video clips or video sequences to be inserted in a video file, audio clips to be inserted into an audio or video file, etc. Based upon the disclosure provided herein, one of skill in the art will recognize a variety of document types that can be used in relation to different embodiments. The document automation system and document editor can manage and edit structured and unstructured data locally on a computer system using one or more programs or applications on the computer system or other computing device, or remotely using a web-based interface over an Internet or other network connection, or using a combination of local and remote processing. Storage of documents with their metadata can be remote as well, such as in the case of using a cloud service.

In some embodiments, the document automation system disclosed herein provides a document metadata filesystem database which stores structured data as metadata associated with document files. Structured data is stored in the metadata of the document, in any manner or file format that differentiates the metadata from the static content of the document. In some embodiments, the file format of the document contains both the unstructured data (body content) of the document and structured data for the document, with the structured data (e.g., values managed by the document automation system) being stored in the metadata of the document. In these embodiments, the metadata filesystem database is contained and stored within the document or documents themselves. This allows the user to employ any existing solutions for sharing, backup, version control, or file permissions, and the document will behave like any other file while still containing a document metadata filesystem database. For example, reverting to a backup of a file reverts both the unstructured content of the file and the structured data in the document metadata filesystem database also contained within the file. Updates to a file by email, from the cloud, from a shared filesystem, etc. will update both the unstructured content of the file and the structured data in the document metadata filesystem database stored in the metadata of the file. Again, the metadata is not limited to any particular format or storage arrangement. In some embodiments, the metadata is stored within the same file as other file content, such as text, spreadsheet data, program code, HTML code, image data, video data, etc. In some other embodiments, the metadata is associated with the file in another manner, such as, but not limited to, in a sidecar file which contains metadata in a separate file associated with the content file, or in a container file such as a Matroska MKV file which can contain video, audio, subtitle, metadata etc. in a single container file, or in an archive file which contains multiple files and which can compress the contents, or in a filesystem fork which can contain a set of data in a filesystem object and which can appear to be a single object when viewed through a file explorer in some operating systems but as multiple files in other operating systems. Based upon the disclosure provided herein, one of skill in the art will recognize a variety of metadata arrangements that can be used to store the document metadata filesystem database in relation to different embodiments.

In some embodiments, the document automation system disclosed herein accesses data by performing graph-like queries over data stored in a key-value structure. An attribute defines a piece of information, for example including an ID or unique identifier and a name. Attributes can be chained to form a path through a graph-like structure to facilitate retrieving information as well as changing relationships between information. For example, three attributes might be defined as follows:

```
{ID: 1,
  Client
}
{ID: 2,
  Date of birth
}
{ID: 3,
  Guardian
}
```

In some embodiments, attributes can be grouped into entities. For example, three attributes might be defined as follows, with an additional Boolean value specifying whether the attribute represents a subgrouping of data, or represents plain text or other simple content:

```
{ID: 1,
  Client,
  Entity: true
}
{ID: 2,
  Date of birth,
  Entity: false
}
{ID: 3,
  Guardian,
  Entity: true
}
```

In this case, the client and guardian attributes represent entities and the date of birth attribute represents a string value. An entity has a unique identifier and a map of attribute-value pairs holding the data for that entity. For example, in some embodiments an entity might represent a person and their information.

Values may be either strings or references to other entities. These references form the edges in an entity graph. The values of attributes are thus organized into graph-like structures, where the graph itself is stored via key-value pairs, and chains of attribute IDs (accessors) are stored as lists. In an entity graph, accessors, such as a list of attribute IDs, specify the location of the desired value. In order to retrieve a value, a root entity in the graph is accessed, and the first attribute or attribute ID in the accessor is looked up in the accessed entity. If the value is a reference to another entity, that entity is accessed and the value of the next attribute in the accessor is looked up in that entity. This process repeats until the final value is found. An accessor represents a path between nodes (entities) in the entity graph, where edges are attributes. Thus, accessors can be used to traverse attributes and entities in graph-like manner to arrive at a value. For example, the client's date of birth can be accessed using the chain of IDs [1,2]. The guardian's date of birth can be accessed by [3,2]. The client's guardian can be accessed by [1,3]. The client's guardian's date of birth can be accessed by [1,3,2]. The document automation system can populate field locations in the document using these accessor chains of attribute IDs. If the client and guardian are the same person, once the date of birth has been entered for the client or guardian, it can be populated anywhere in a document or group of documents where the field locations containing the client date of birth and guardian date of birth appear. Changes to values also benefit from this graph-like structure. Again, if the client and guardian are the same person, and any date of birth attribute is changed for the client or guardian, that change will manifest for all field locations that reference the client's date of birth and the guardian's date of birth.

Accessors provide an abstracted path through an entity graph using attributes, which define a piece of information and which can appear in multiple accessors. For example, an entity (which in some embodiments might represent a person) can have many attributes. A person may have a birthday and a home address. When that person is used in multiple contexts, any change to their attributes is changed in each role in which the person appears. Attributes can be used as the list of entries in an accessor to look up data, which enables the document automation system to reuse attributes such as address in multiple places. The address of an agent, for example, can be looked up using the accessor [“agent”, “address”]. Given accessors [“agent”, “address”] and [“guardian”, “address”], if “agent” and “guardian” are the same person, their address is the same, and changing it in one location will change it in others. The reuse of attributes in multiple accessors thus avoids redundancy in both data entry and storage. This approach decouples the exact definition of the properties from their usage so that entities can be reused with minimal redundancy.

The document metadata filesystem database, editing of unstructured data alongside structured data, and data queries on graph-like structured data can be independently embodied in a document automation system, or can be variously combined in a document automation system, with some embodiments of a document automation system including all of these elements. These elements provide improvements in computing technology, using a unique database system to store data to be populated into documents, which can be traversed in graph-like manner using attribute-based data accessors. Unlike some traditional database systems in which each piece of data is uniquely addressed and retrieved by looking up that address, the accessors to graph-like structured data allow the paths to desired information to be modified based on the data values in the database, with entity graphs shifting and changing as data is changed and as relationships between data are modified. This querying system/entity graph structure is independent of the document metadata filesystem database, indeed it could be implemented in traditional database systems, with the document automation system providing and using a unique structure for the structured data. This provides a flexible and efficient way to, for example, update structured data in one or more documents easily and without redundancy, keeping the document or documents up to date uniformly as changes to any values are made. The reuse of attributes in multiple accessors enables multiple paths through the data to be easily traced and for entity graphs to be shifted and redefined as changes to values are changed, without requiring static addresses or paths to data and without redundancy in data entry or data changes. The metadata storage of data in some embodiments enables structured and unstructured data in one or more documents to remain linked as the document files are transferred, shared, restored from backup, processed by version control systems, etc. The database which can be accessed using accessors to traverse entity graphs remains in the documents, so the structured data remains dynamic and can be changed and automatically updated using accessor-based entity graphs, even while the body or unstructured data of the documents can be modified and saved. In other words, the database is contained within the documents themselves.

In the following description, numerous specific details are set forth in order to provide a thorough understanding of embodiments. It will be apparent to one skilled in the art, however, that embodiments may be practiced without some of these specific details. In other instances, well-known structures and devices are shown in block diagram form.

The phrases “in one embodiment,” “according to one embodiment,” “in various embodiments”, “in one or more embodiments”, “in particular embodiments” and the like generally mean the particular feature, structure, or characteristic following the phrase is included in at least one embodiment, and may be included in more than one embodiment. Importantly, such phrases do not necessarily refer to the same embodiment.

Embodiments of the present developments include various steps, which will be described below. The steps may be performed by hardware components or may be embodied in machine-executable instructions, which may be used to cause a general-purpose or special-purpose processor programmed with the instructions to perform the steps. Alternatively, the steps may be performed by a combination of hardware, software, firmware and/or by human operators.

Embodiments of the present developments may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware). Moreover, embodiments hereof may also be downloaded as one or more computer program products, wherein the program may be transferred from a remote computer to a requesting computer by way of data signals embodied in a carrier wave or other propagation medium via a communication link (e.g., a modem or network connection) and then stored on a tangible machine-readable storage medium.

In various embodiments, the article(s) of manufacture (e.g., the computer program products) containing the computer programming code may be used by executing the code directly from the machine-readable storage medium or by copying the code from the machine-readable storage medium into another machine-readable storage medium (e.g., a hard disk, RAM, etc.) or by transmitting the code on a network for remote execution. Various methods described herein may be practiced by combining one or more machine-readable storage media containing code associated with the document automation system with appropriate standard computer hardware to execute the code contained therein. An apparatus for practicing various embodiments of the present developments may involve one or more computers or computing devices (or one or more processors within a single computer) and storage systems containing or having network access to computer program(s) coded in accordance with various methods described herein, and the method steps could be accomplished by modules, routines, subroutines, or subparts of a computer program product.

Notably, while embodiments hereof may be described using modular programming terminology, the code implementing various embodiments hereof is not so limited. For example, the code may reflect other programming paradigms and/or styles, including, but not limited to object-oriented programming (OOP), agent oriented programming, aspect-oriented programming, attribute-oriented programming (@OP), automatic programming, dataflow programming, declarative programming, functional programming, event-driven programming, feature oriented programming, imperative programming, semantic-oriented programming, functional programming, genetic programming, logic programming, pattern matching programming and the like.

Terminology

Brief definitions of terms used herein are given below.

The phrase “document automation system” is used herein to refer to a software or software and hardware combination that enables concurrent editing of structured data (e.g., field locations and values) alongside unstructured data (e.g., document text). In some cases, the document automation system stores structured data as metadata in a document file along with unstructured data. In some cases, the document automation system provides graph-like access of data using accessors to traverse entities and their attributes to access a desired value.

The term “plugin” is used herein to refer to a software application used to edit structured data in one or more documents in conjunction with another document editing application which can be used to edit unstructured data in the one or more documents. In some embodiments, the plugin is integrated into the document editing application, for example using an application program interface (API) associated with the document editing application to edit the structured data. In some embodiments, the plugin receives changes to structured data made using the document editing application and propagates the changes throughout the one or more documents. In some other embodiments, structured data is entered directly into the plugin and applied to the one or more documents, either via the document editing application or directly to a file, in which case the document editing application detects the changes to the structured data. In an example embodiment, the document editing application is a word processor such as, but not limited to, Microsoft Word, and the plugin is a Microsoft Word add-in.

The phrase “document automation application” is used herein to refer to a software application including a matter manager and a state synchronization backend, which communicates with one or more plugins to monitor changes to structured data and to propagate those changes to synchronize the state of the structured data in a document or documents. The matter manager provides a user interface enabling a user to manage projects or groupings of documents and their structured data, adding or removing projects and working within any particular project.

The phrase “state synchronization backend” is used herein to refer to a non-GUI software module of the document automation application that performs state synchronization. The state synchronization backend is a subset of the document automation application that listens over the network and to the filesystem for state changes, applies them using a state change manager and forwards them to open and closed templates.

The term “field”, also referred to as an “attribute”, is used herein to refer to the definition of a piece of information in the structured data managed by the document automation system. For example, in some embodiments an attribute may be a “date of birth” or a “spouse”. The attribute does not specify whose “date of birth” or “spouse”, solely their meaning.

The phrase “attribute ID” is used herein to refer to the unique identifier of an attribute.

The phrase “field location” is used herein to refer to a marker in the unstructured data of a document that ties a location in the document to a value, indicating that a value should be placed there. In some embodiments, a field location also contains an accessor in order to specify which value should be placed at that location.

The term “value” is used herein to refer to a piece of information (structured data) that the document automation system populates or updates at a field location in one or more documents. Each field location has a corresponding value.

The term “entity” is used herein to refer to a grouping of attributes and corresponding values. Notably, in some embodiments, values are stored in entities with an attribute as the identifier.

The phrase “entity graph” is used herein to refer to a collection of entities containing their attributes and values. An entity graph includes a root entity and zero or more entities that may be inter-related by references in one entity to another entity. In some embodiments, entities are linked by setting the value of an attribute in an entity to be a reference to or ID of another entity. In other words, entities may connect to each other since a value in an entity may be a reference to another entity. These connections form the edges in the graph structure where the entities are the vertices.

The phrase “root entity” is used herein to refer to an entity that is the starting point for looking up a value in an entity graph according to an attribute chain.

The term “accessor” (also referred to as an “attribute chain”) is used herein to refer to a list of attributes (or attribute IDs) that specify the location of the desired value in an entity graph. Where entities form nodes in the entity graph, fields or attributes form edges connecting the entities. The first field or attribute in the accessor is retrieved from a root entity. The value of each field or attribute in the accessor except the last field or attribute in the accessor is a reference to another entity, and the last field or attribute in the accessor contains the value that is populated into the field location in the document.

The term “metadata” is used herein to refer to information associated with a document that is not visible in the text or content of the document, in which structured data can be stored.

The phrase “structured data” is used herein to refer to information managed by the document automation system, such as, but not limited to, attribute definitions and values and accessors.

The phrase “unstructured data” is used herein to refer to document content that is not managed by the document automation system, such as the text of a text document other than attribute IDs and values.

The term “template” is used herein to refer to a document containing unstructured data and field locations which can be reused, edited, and in which values can be populated by the document automation system.

The term “project” is used herein to refer to a grouping of one or more documents and their metadata. In some embodiments, it can also be used to refer to such a grouping of documents and their metadata in a folder (whether or not a watched project, and therefore while the metadata is all in the documents, and state changes can be made, no state synchronization happens until it becomes a watched project.)

The phrase “watched project” is used herein to refer to a project being watched by a state synchronization backend, e.g., in a document automation application.

The term “state” is used herein to refer to metadata containing information about zero or more attributes and field locations, and an entity graph containing any values.

The phrase “state change” is used herein to refer to one or more changes to be applied to a state, which can include an attribute or entity or entities within a document automation project. An example of a state change includes a manifest of individual changes to the document state that have been applied. It can be initiated from a user working in an open document or a user working in the document automation application, or from the file system (i.e. by a closed document being added to a project folder.)

The phrase “global state” is used herein to refer to the state maintained by the state synchronization backend of the document automation application containing all the information from all the states within a project. In some embodiments, the global state is computed as an intermediate step in synchronizing, and is not a storage mechanism.

The phrase “minimal state change” is used herein to refer to a state change requiring the least amount of changes needed to achieve a consistent state between a particular document state and the global state.

The phrase “state change manager” is used herein to refer to a code module or circuit that applies a state change to a given state using a “conflict resolution method” such as, but not limited to, the timestamp-based method of resolving conflicts between state changes, or a user or administrator approval of state changes to resolve conflicts.

The phrase “metadata format parser” is used herein to refer to a code module or circuit that handles writing the state in a format compatible with the format of the document's metadata.

The phrase “attribute inputs” is used herein to refer to inputs from a user specifying the values of attributes. In some embodiments, the attribute inputs are received through a form in a user interface.

The phrase “static document” is used herein to refer to a document that does not have field locations or a plugin, and is not connected to a document automation system. A static document can result from traditional document automation software after a merge operation, for example to merge values in a spreadsheet into field locations in a word processing document which replaces field locations with static values, such that field locations and values are no longer linked.

The term “redundancy” is used herein to refer to having to manually update multiple field locations within a project due to a change to a value, and can also be used to refer to storing multiple copies of the same data, e.g., multiple copies of the same values.

The term “reference” is used herein to refer to a value which points to an entity resulting in a look up path between entities in an entity graph, where the look up path is a series of these individual edges or references, with a reference connecting two entities in an entity graph.

The term “propagation” is used herein to refer to state synchronization as to a single state change, applying a state change to all the document states and to the global state of a watched project to effect a consistent (global) state.

The term “link” is used herein to refer to a connection between field locations in a document and corresponding values in a spreadsheet or database, and which does not survive a merge in traditional document automation software.

The term “decouple” is used herein to distinguish the definition of properties from their usage in a document so entities can be reused with minimal redundancy, eliminating the need to manually change information in multiple places.

If the specification states a component or feature “may”, “can”, “could”, or “might” be included or have a characteristic, that particular component or feature is not required to be included or have the characteristic.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

In some embodiments, the document automation system disclosed herein is designed to automate the re-use of document templates across multiple projects. Various embodiments have one or more of the following characteristics and benefits:

Data entry does not require re-entering redundant information.

A user can define a group of templates, a ‘project’, that should maintain a consistent state under any changes.

Templates are reusable across projects, but with different data.

Templates are editable in a user's document editor, like any other document.

Changes to the content of the template, and those within the document automation system are permitted in parallel.

Changes to the templates outside of the document automation application are allowed, and the document automation application responds accordingly to those changes.

Any suitable document editor can be used based on the type of content being created, such as, but not limited to, text documents, spreadsheets, HTML documents, image files, computer executable source code, audio, video, etc. For example, a web-based word processor such as Google Docs or a standalone word processor such as Microsoft Word can be used to edit the content of templates while the document automation system propagates changes to attributes, values, entities, etc. in the structured data of a document, project or multiple projects.

In some embodiments, the document automation system includes a plugin such as a web-language-based Addin to Microsoft Word, or any other software module that can integrate with a document editor of any type. For a plugin to a word processor, the plugin provides the user interface for an individual template, and is embedded within the user's word processor, for example providing a user interface to define entities and attributes, and to enter values for attributes. In some embodiments, the document automation system also includes an application, which provides a user interface for assigning groups of templates or ‘projects’, and manipulating the data for all templates within these projects. The application also runs in the background to watch for changes and keep all templates in a project in sync. By partially integrating the software directly into the user's text editor, the document automation system allows for parallel changes to structured and unstructured data. Without this, any content changes to must be anticipated by the user before the template is populated with data and a static document is produced.

In some embodiments, each instance of the plugin is only directly aware of the document it is associated with. The document state is stored in the document itself using document settings, a type of metadata. When the plugin loads, it retrieves the state if available from these settings. The structure of the state in some such cases includes:
attributes: the definitions for each known attribute used in the document. It is an object with keys being unique attribute ids, and their values being an object with properties:
   name: name of attribute for display purposes
   entity: optional, if true the value should be filled with a reference to an entity rather than a string value
   ts: timestamp of most recent changes for conflict resolution
   entity graph: all of the values available for the entire project. The data for the project is broken up by entity. Attributes not belonging to an entity are stored under the root entity with id 0. To retrieve a specific piece of information, say [1,2], the document automation system starts at the root entity, finds the value of attribute 1, uses that value to find the next entity, then gives the final value as the value of that entity's attribute 2.
   controls: a list of all field locations and their accessors in the document(s) that the state is bound to.

In some embodiments, the document automation system uses a unique database system to store the data that will be populated into the templates. In some embodiments, the document automation system stores the data for each template in that template's metadata. Any file format that may embed metadata outside the text content itself is suitable, whether in the file system object for the template or document itself, or in any other manner that associates the metadata with the template or document, such as, but not limited to, using metadata sidecar files or in a filesystem fork. The benefit of this is that a user may employ any existing solutions for sharing, backup, version control, or permissions and the document automation system templates will behave like any other file. For instance, reverting to a backup of a file, also reverts to the data in that backup. Updates to files from the cloud, or from a shared filesystem will update the data within the document automation system as well. To achieve this, the document automation system keeps changes to all templates in a project in sync, and changes to templates made outside the document automation system from the filesystem itself must be valid and are synchronized by the document automation system throughout all templates in the project.

In order to maintain a consistent state within a set of documents, the document automation system generalizes all changes to the state as a ‘state change’. A state change contains a subset of the data that has been updated, and in some embodiments, the timestamp of when each piece of data was set. A state change may come from the following sources:

An open template (connected via the plugin)

A closed template on the filesystem (changed by an external source)

The document automation system application.

Regardless of its origin, every state change is picked up by the document automation system application either through the local network (in the case of an open template) or the filesystem (in the case of a closed template). For each project known to the document automation system, the application computes an intermediate ‘global state’ of all data for all the templates in that project. The application applies every incoming change to the project's global state. Applying a change may include comparing each piece of data in the state change to the corresponding data in the global state, and updating the global state if the state change has a more recent timestamp. This ensures that only the user's most recent changes are applied in race conditions. Once the global state is updated by the change, each template in the project is sent its own state change based on its current state. Open templates are sent the state change through the plugin, and closed templates are updated by the application directly through the filesystem.

In a project, there can be many separate templates that should all maintain a consistent state for their attributes and values. State changes can be initiated from an open plugin by a user manipulating a value in the user interface, or from the filesystem by a file being modified in or added to a project folder. Regardless of the source of a state change it is handled by the state synchronization backend, or document automation application in the same manner:

1. Merge the state from the document into the global state, using the timestamp properties to resolve any conflicts so that the newest change is always used.

2. Iterate over each document in the project and compute the subset of the global state that is used in that document (what attributes and data actually appear in the document.)

3. Compare each document's state to their newly computed state if they do not match, then:
if the document is open, send a message to its plugin informing it of the state change
otherwise, access the document metadata and update the state on the filesystem.

The document automation system retrieves data to be populated into a document using defined ‘attributes’. An attribute is the definition of a piece of information and may appear in multiple accessors. With attributes, the accessor “AGENT′S ADDRESS” would be defined as the chain of attributes [“agent”, “address”]. This allows attributes like “address” to be reused in multiple places. Given accessors: [“agent”, “address”] and [“guardian”, “address”], and if “agent” and “guardian” are the same person, their address should be the same. Changing it in one place changes it in the other, which is made possible by reusing attributes in multiple accessors.

The document automation system uses a hierarchical structure with the attribute based accessors. The document automation system stores its values using entities. An entity has a unique identifier and a map of attribute-value pairs holding the data for that entity. In some embodiments, such as in some text document embodiments, an entity represents a person and their information. Values may be either strings or references to other entities in the form of an entity ID. These references form the edges in an entity graph, the structure the document automation system uses in some embodiments to store its data.

In an entity graph, accessors specify the location of the desired value. In order to retrieve a value, given an accessor the document automation system starts at a special entity in the graph called the ‘root entity’. The first attribute from the accessor is popped from the list and its value is looked up in the entity. If the value is a reference to another entity the document automation system moves to that entity, pops the next attribute and looks up its value. This process repeats until the final value is found. An accessor represents a path between nodes (entities) in the entity graph, where edges are attributes. Storing and accessing data in this way has many advantages:

A user can reference an existing entity when entering data, bringing along all of its dependent information, eliminating redundancy.

Updating a value in an entity will manifest everywhere that entity is referenced by accessors, regardless of the context.

Changing a value from one entity reference to another immediately changes all values that are further down in related accessors.

Arbitrary entities may be marked as the ‘root entity’ for a specific document, implying ownership of that document, allowing multiple versions of the same template with different information within a project.

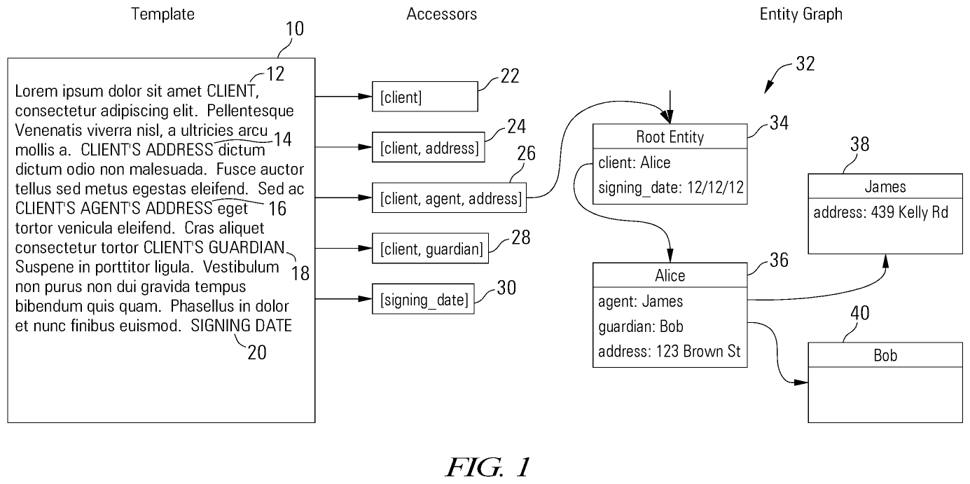

Turning to FIG. 1, a diagram depicts a template 10 marked with field locations 12, 14, 16, 18, 20, identified by an accessor (e.g., 22, 24, 26, 28, 30) and an example entity graph 32 associated with one of the accessors 26 in accordance with one or more embodiments hereof. The document automation system marks ‘field locations’ 12, 14, 16, 18, 20 within the template 10. These field locations 12, 14, 16, 18, 20 are identified by an accessor (e.g., 22, 24, 26, 28, 30), which is a chain of attributes. The example accessor 26 and its associated entity graph 32 illustrate how the document automation system retrieves the value for the field location 16. All values in the document automation system are stored in entities. An entity includes an entity id and a set of attributes and their corresponding values. Multiple entities come together to form an entity graph from which all values in the project can be retrieved.

In every entity graph there is one root entity which describes attributes that do not belong to any person (for examples in which entities represent people). Non-root entities represent values for a particular person. Any value that is a person is simply a reference to that person. When retrieving a value from an entity graph using an attribute chain, the first step is to look for the first attribute in the attribute chain in the root entity. If that value is a reference to another entity, the next attribute in the attribute chain is found in that entity. This process is repeated until the desired value is found.

The accessor 26, [client, agent, address], begins with a root entity 34 which contains attributes client (“Alice”) and signing_date (12/12/12). The first entry of the accessor 26, client, identifies the client attribute in the root entity 34, which references the Alice entity 36. The Alice entity 36 contains attributes agent (“James”), guardian (“Bob”), and address (“123 brown st”). The second entry of the accessor 26, agent, is popped from the accessor list and is used to identify the agent attribute in the Alice entity 36, which references the James entity 38. The James entity 38 contains attribute “address” with value (“439 kelly rd”). Thus, the attribute identified by accessor 26 [client, agent, address] is in the James entity 38 and contains value, “439 kelly rd”, which is populated into the field location 16 in the template 10. Notably, populating this value into the field location 16 in the template 10 does not break the link between the field location 16 and the document automation system. In other words, the value “439 kelly rd” is not statically inserted into the template 10, and does not replace field location 16. This allows the value populated into field location 16 to be updated by the document automation system as well as allowing the static content or unstructured content of the template 10 to be edited concurrently. A document template can thus be updated while continuing to allow the document automation system to apply and synchronize changes to values, to accessors, to entities, etc. Although one example accessor 26 and its associated entity graph 32 has been described, in some other embodiments a template 10 can include many entity graphs, all originating from the same root entity 34 in some embodiments, and using many entities (e.g., 34, 36, 38, 40). As the data in a document automation system project changes and is synchronized, individual documents retrieve their needed data through accessors and populate them into the document in real time.

Using a metadata enabled format such as, but not limited to, the docx format of Microsoft Word to store data allows the metadata to be modified without compromising the consistency of the database and can be beneficial not only in the document templating disclosed above, but in business intelligence, visualization and analytics tools, etc. For example, metadata can be accessed, viewed, and condensed to determine how often files are being edited and by whom, how documents are being used (industry by industry, or department by department), what documents are being used in combination, and whether additional metadata is required, or beneficial, to optimize such tools.

By employing user-created, user-editable documents (whether or not text-based) as part of a larger project to establish a global state, the document automation system enables shared-state applications across project documents where documents or their metadata have relevancy to each other and copies can be modified separately—all within a document (or project manager) interface, as a user-friendly alternative to spreadsheets and other traditional database interfaces.

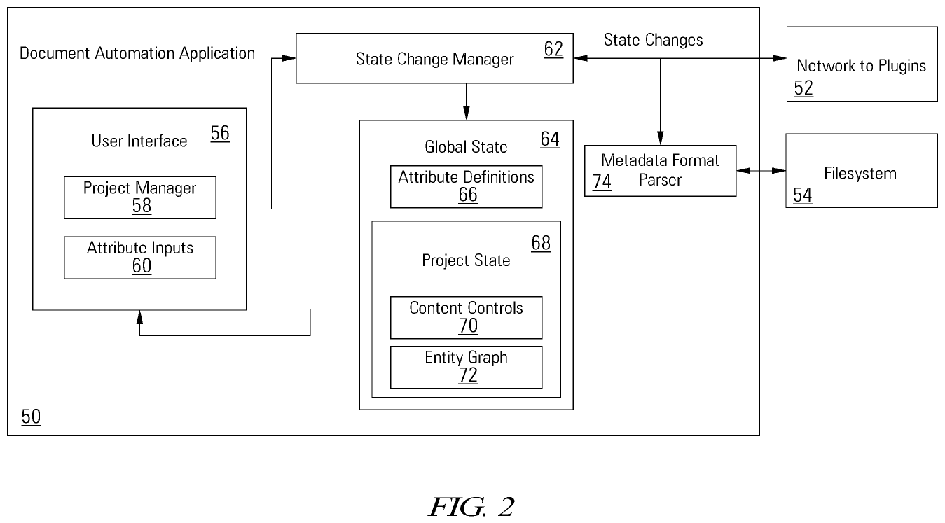

Turning to FIG. 2, a block diagram of a document automation application 50 is depicted in accordance with one or more embodiments hereof. A document automation application 50 is configured to communicate with one or more plugins over a network 52 or with a filesystem 54 to receive and to make changes to structured data in templates or documents, such as changes to values, and in some embodiments to entities and entity graphs. The network 52 can be any suitable communications link and protocol, including a network protocol implemented on a single computer, between multiple computers on a local area network, multiple computers on a wide area network, using wired and/or wireless connections, etc. The document automation application is not limited to use with any particular type of network, and based upon the disclosure provided herein, one of skill in the art will recognize a variety of networks that can be used in relation to different embodiments hereof. Similarly, the filesystem 54 can be any filesystem or combination of filesystems, including remote filesystems, that can store and retrieve document files with embedded or otherwise associated metadata.

The document automation application 50 includes a user interface 56 which in some embodiments includes one or both of a project manager 58 and an attribute input interface 60. The project manager 58 is a user interface, whether graphical and/or command line, which enables users to create and manage projects, groupings of one or more documents and their metadata or structured data. The attribute input interface 60 enables users to create and manage attributes or attribute definitions, and in some embodiments, values to be populated throughout field locations for the attribute in any documents in the project containing the field locations. In some embodiments, the user interface 56 can be adapted to manage unstructured data in the document as well as structured data.

The document automation application 50 also includes a state change manager 62, and a state synchronization backend of the document automation application 50 which receives state changes from the user interface 56 or from document plugins via the network 52 or changes in templates or documents made directly in the filesystem 54. The state change manager 62 also propagates changes to structured data throughout documents in projects. In some embodiments, the state change manager 62 determines a minimal state change to be provided to plugins for application in open documents or to be applied to closed documents via the filesystem 54, where the minimal state change is the least amount of data determined by the global state that needs to update a particular document's state. When multiple changes are made to the same attribute, the state change manager 62 in some embodiments examines a timestamp on each change and determines which change to apply in the project, for example applying the latest state change.

The document automation application 50 also includes a global state 64, which is the state computed by the state synchronization backend of the document automation application 50 comprised of all the information from all the states within a project or projects. The global state 50 includes attribute definitions 66 and project states 68. Project states 68 can include field locations 70 (e.g., content controls in Microsoft Word), and an entity graph 72, which define paths through an entity graph from an attribute in the root entity to each desired value. When changes are made to the global state 64 by the state change manager 62, the user interface 56 can also be updated based on the global state 64 so that the user interface 56 displays the updated information.

The document automation application 50 also includes a metadata format parser 74 to interpret metadata in document files in the filesystem 54, enabling the state change manager 62 to retrieve and to update structured data stored in the metadata in document files in the filesystem 54. For example, where Microsoft Word documents are stored in the filesystem 54 in docx format and metadata is in XML format, the metadata format parser 74 comprises an XML parser configured to retrieve and update attributes and other structured data stored in the XML metadata of the Microsoft Word documents for the document automation system.

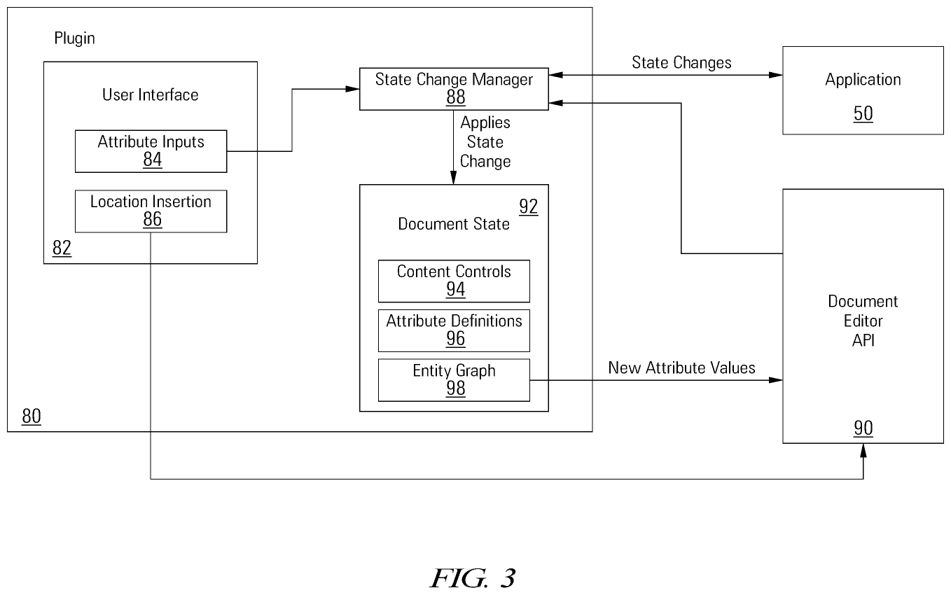

Turning now to FIG. 3, a block diagram of a document automation plugin 80 is depicted in accordance with one or more embodiments hereof. The document automation plugin 80 is configured to interface with a document editing program and to update attributes or attribute definitions and values in a document that is open in the document editing program. For example, in some embodiments, given a Microsoft Word document, the document automation plugin 80 may comprise an Addin to Microsoft Word. The plugin 80 includes a user interface 82 which in some embodiments includes one or both of an attribute input interface 84 and a field location insertion module 86. The user interface 82 enables the user to define attributes and their values, as well as the entities, accessors and entity graph that control the relationships between attributes and how they are retrieved. The field location insertion module 86 enables the user to insert a field location into the document associated with the plugin 80. For example, if the plugin 80 is associated with a Microsoft Word document, the field location insertion module 86 enables the user to insert a field location in the Word document, marked in the document as being content controlled, so that the value of the field location can be updated by the plugin 80 and displayed in the document. The document can then be viewed, saved, printed, transmitted, etc., with the value remaining controllable by the plugin 80 in the document automation system rather than being converted to static text. In some embodiments, the view mode of the document can be toggled to either display the attribute definition or the value of the attribute.

The plugin 80 also includes a state change manager 88 which receives state changes from the user interface 80 or from the document automation application 50 or from a document editor application program interface (API) 90. State changes from the document automation application 50 are based, for example, on changes to structured data in other open or closed documents in the same project, where the document automation application 50 was notified of a state change by a plugin associated with another open document in the project, or detected a state change in a closed document by monitoring the filesystem, and where the document automation application 50 determined a minimal state change to be applied by the plugin 80 to the document associated with the plugin 80.

The state change manager 88 applies state changes to the document state 92, which can include, for example, content controls 94 or field locations, attribute definitions 96 and entity graphs 98. Attributes defined in the user interface 82 can be inserted in a document, and values in the document state 92 determined by the state change manager 88 can be updated in the document via the document editor API 90. Changes made to field locations or values directly in the document by the document editor can be communicated to the state change manager 88 by the document editor API 90 and used to update the document state 92, as well as the application 50. Changes in the document state are also communicated to the application 50 by the state change manager 88 so that the global state can be updated by the application 50 and changes can be synchronized in other documents in the project.

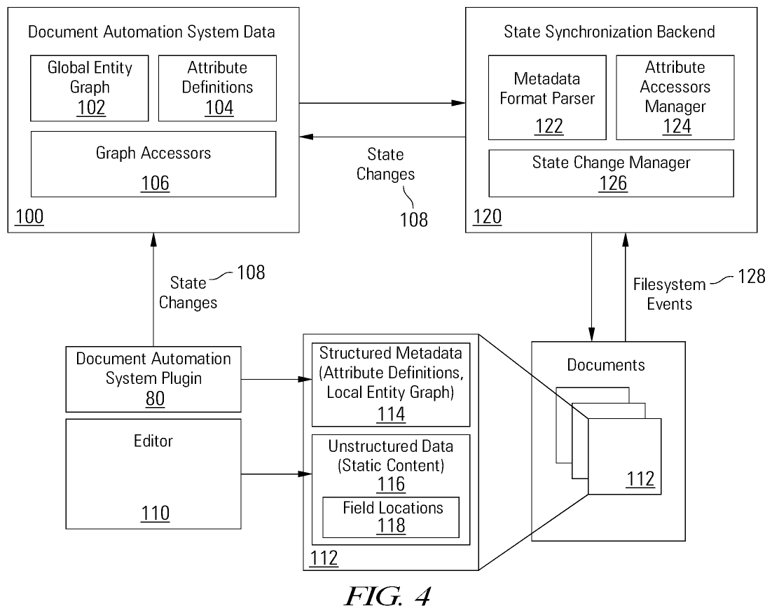

Turning now to FIG. 4, a block diagram depicts data storage in some embodiments of a document automation system. The document automation system structured data 100 can include a global entity graph 102, attribute definitions 104, and graph accessors 106, updated by state changes 108 which come from attribute inputs. The global entity graph 102 defines the links between entities in the project. The attribute definitions 104 define each piece of information in the structured data 100. As an example, in some embodiments in which the document is a text document, the entities may represent people and attributes in the entities define information about each person, where the attributes can contain values or references to other entities. The graph accessors 106 define the path from a root entity through entities to each target attribute to be retrieved and populated in field locations in the documents. The state changes 108 are changes to values or to other information in the structured data 100, which are generated by the plugin 80.

The structured data 100 can be stored as metadata 114 in the document file. Where multiple documents are grouped in a project, the metadata of each document file can store the structured data of just that document or of every document in the project. In some other embodiments, structured data 100 can be stored in metadata files associated with the document file.

A document editor 110 can be used to edit the static content or unstructured data of a document (e.g., 112), such as the body of a text document other than the field locations in the document which are populated by the document automation system. The document automation system enables the structured data 114 such as attribute definitions and entity graphs to be edited concurrently with the unstructured data 116, and the document or template can be saved with the edits to both types of information, without breaking the link between the field locations 118 in the document and the structured data 100.

A state synchronization backend 120 includes program code modules such as a metadata format parser 122, an attribute accessors manager 124, and a state change manager 126. The state synchronization backend 120 exchanges information with the structured data 100 (in some embodiments via the plugin 80), and with closed documents (e.g., 112) via a filesystem, for example reacting to filesystem events 128. The metadata format parser 122 is configured to extract structured data for the document automation system from metadata in or associated with a document, either through the plugin 80 for an open document or through the filesystem for a closed document. The state change manager 126 is configured to receive filesystem events 128 for monitored files or folders, detecting when the file for a document in the project has been modified, and detecting changes if any to structured data in the document. The state change manager 126 identifies changes to structured data in the project and propagates the changes throughout the project, for example implemented by the state change manager 62 in the application 50 identifying the minimal state change to be provided to each plugin or closed document in the project. The attribute accessors manager 124 is configured to update accessors that provide the path or map from a root entity to a desired field or attribute.

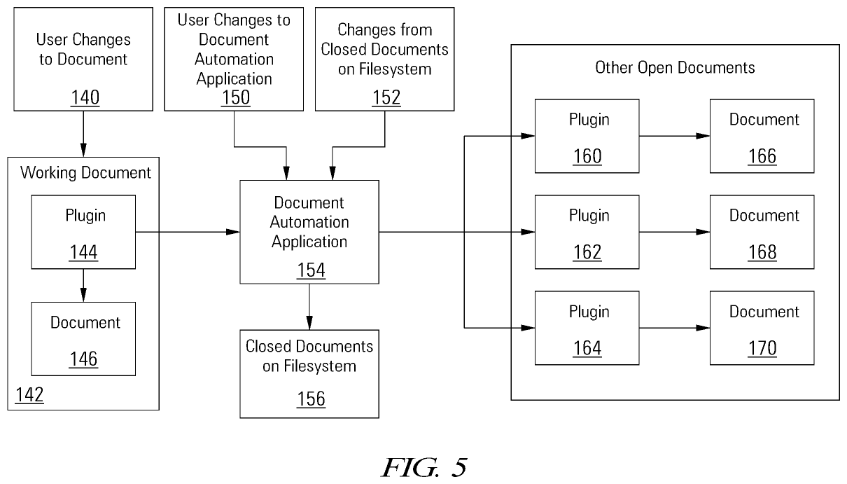

Turning now to FIG. 5, a flow diagram of updates in a document automation system is depicted in accordance with one or more embodiments. In this example of a project, there are many interrelated documents (e.g., 146, 156, 166, 168, 170) that should all maintain a consistent state for their attributes and values. Any user action to attributes or entities within a project can be expressed as a state change. User state changes 140 can be initiated from a user working in an open document, either directly in the document via the document editor or in the user interface plugin 144 associated with the document 146, which together form a working document 142. User state changes 150 can also be initiated in the user interface 154 of the document automation application. A state change 152 may also come from the filesystem, for example a closed document being added to a project folder, or new changes from a shared filesystem. Each state change is sent to the state synchronization backend in the document automation application 154, which can generate a minimal state change to be applied to other documents in the project. This minimal state change is sent to the plugins (e.g., 160, 162, 164) of open documents (e.g., 166, 168, 170), or saved to the file system for closed documents 156.

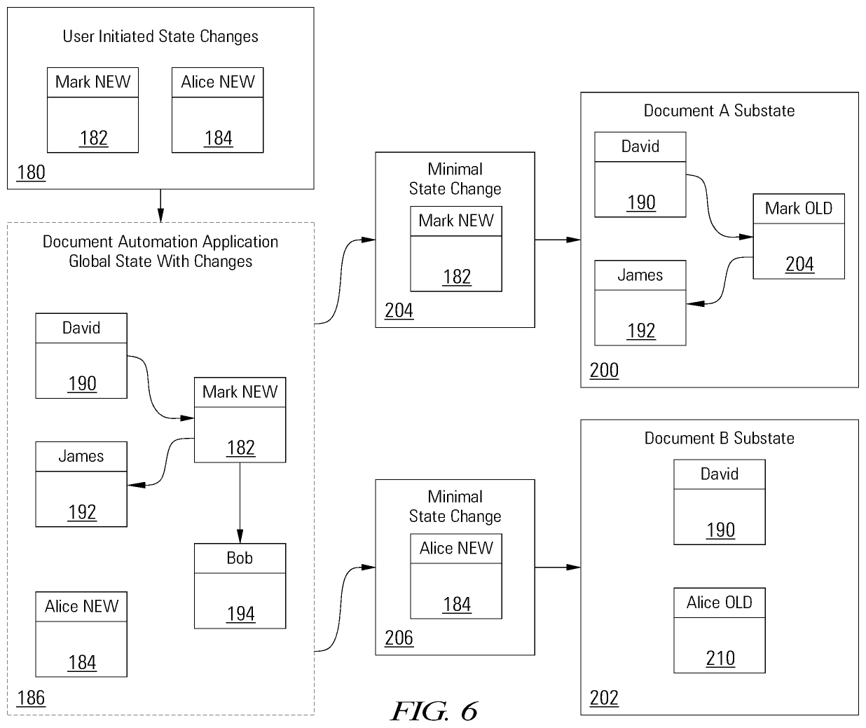

Turning to FIG. 6, a flow diagram of a document automation system propagating state changes is depicted in accordance with one or more embodiments. User initiated state changes 180 such as new entities 182, 184 are provided to and applied to the document automation application global state 186. For example, the new entities 182, 184 are inserted into the entity graph with existing entities 190, 192, 194. The state change manager of the document automation application decides what other documents 200, 202 in the project need to be updated based on the state changes 180, generating a minimal state change 204, 206 for each document 200, 202 to be updated. For example, a minimal state change 204 for document 200 includes the new entity 182, which replaces or updates the previous corresponding entity 204 without having to send data for unchanged existing entities 190, 192 in the document 200. Similarly, a minimal state change 206 for document 202 includes the new entity 184, which replaces or updates the previous corresponding entity 210 without having to send data for unchanged existing entity 190 in the document 202.

Wherever a state change comes from, it is sent to the state synchronization backend of the document automation application which decides what other documents need to be updated. A state change is handled by the state synchronization backend in the following manner:

1. Apply the state change to the project's global state. Any conflict between the new state and the old state is resolved by looking at the timestamps and taking the most recent changes.

2. Iterate over each document in the project and compute the new document state based on the global state.

3. For each document send the minimal state change that is needed to bring the document's state up to date with the most recent state change.

This approach ensures a consistent final state for each document since any state change is mediated by the state synchronization backend. Thus, no two documents in the same project will have conflicting data, and only the most recent changes by the user are actually applied. Given the unique data storage mechanism of the document automation system, the distributed storage for a project is kept in sync under any user action. This allows the document automation system to be agnostic about the user's workflow into which it is integrated.

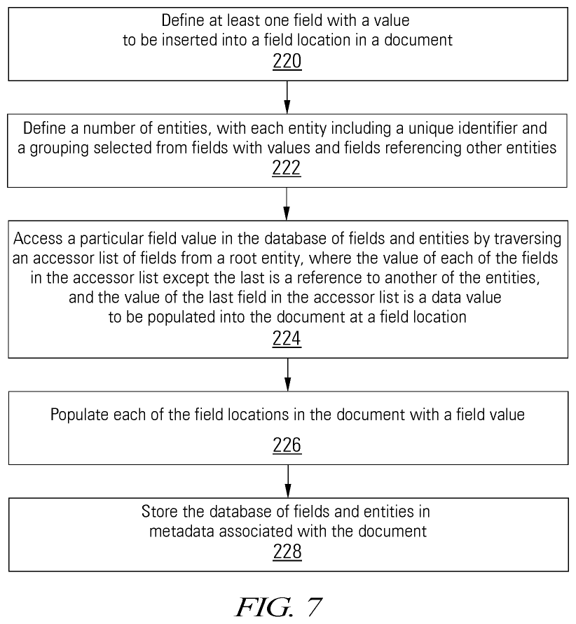

Turning now to FIG. 7, a flow diagram depicts a method for document automation and storing a database in document metadata in accordance with some embodiments. The method of FIG. 7, or variations thereof, may be performed in document automation systems such as those illustrated in FIGS. 1-6. Following the flow diagram of FIG. 7, the method includes defining at least one attribute with a value to be inserted into field locations in a document. (Block 220) A number of entities are defined, with each entity including a unique identifier and a grouping selected from the attributes with values and attributes referencing other entities. (Block 222) The method also includes accessing a particular value in the database of attributes and entities by traversing an accessor list of attributes from a root entity, where the value of each of the attributes in the accessor list except the last is a reference to another of the entities, and the value of the last attribute in the accessor list is a data value to be populated into the document at a field location. (Block 224) The method also includes populating each of the field locations in the document with a value. (Block 226) The database of attributes and entities are stored in metadata associated with the document. (Block 228)

As noted above, the database of the document automation system can be stored as metadata in the document, or in each document of a project, or in metadata associated with the documents and stored in any suitable manner. The metadata can be of any format. As an example, the following is a representation of a field location (in Content Control) in a docx format Microsoft Word document:

<w:sdt>

<w:sdtPr>

<w:rPr>

<w:color w:val=“000000”/>
<w:sz w:val=“32”/>
<w:szCs w:val=“32”/>

</w:rPr>
<!-- tag value contains json encoded accessor -->
<w:tag w:val=“DocAutomation:[

<!-- each attribute in the accessor is fully defined -->

{‘id’:‘15acdaa364ecb5c564743266fd3’,‘name’:‘Client’,‘entity’:true,‘ts’:1489509168719},

{‘id’:‘15acdaacc6c1681fa2fbc1dc397’,‘name’:‘City’,‘entity’:false,‘ts’:1489509207148}

]”/>
<!-- MS Word Content Control Identifier -->
<w:id w:val=“−1463257780”/>
<w:placeholder>

<w:docPart w:val=“8262B502816F2144805550B945569658”/>

</w:placeholder>

</w:sdtPr>
<w:sdtEndPr/>
<w:sdtContent>

<w:r w:rsidR=“00D90804”>

<w:rPr>

<w:color w:val=“000000”/>
<w:sz w:val=“32”/>
<w:szCs w:val=“32”/>

</w:rPr>

<!-- text content of the field location -->

<w:t>Boulder</w:t>

</w:r>

</w:sdtContent>

</w:sdt>

The following is an example of JSON encoded attribute definitions:

{//Keys are attribute IDs, values are attributes

“15acdaa364ecb5c564743266fd3”: {

“name”: “Client”, //Attribute display name
“entity”: true, //Type: entity or string
“ts”: 1489509168719 //Timestamp of creation/change

},
“15acdadca13c51b1badb39a28bf”: {

“name”: “FPOA Agent 1”,
“entity”: true,
“ts”: 1489509403155

},
“15acdae1d72801cb3ee6bfbeff0”: {

“name”: “FPOA Agent 2”,
“entity”: true,
“ts”: 1489509424498

},
“15acdab622c2b872ac8bf50b0b7”: {

“name”: “MDPOA Agent 1”,
“entity”: true,
“ts”: 1489509245484

},
“15acdabc5635dda383f10ad82fc”: {

“name”: “MDPOA Agent 2”,
“entity”: true,
“ts”: 1489509270883

},
“15acdabf02ba8e1787398c8261c”: {

“name”: “MDPOA Agent 3”,
“entity”: true,
“ts”: 1489509281835

},
“15acdaa71196c89c41741fa987”: {

“name”: “Aka”,
“entity”: false,
“ts”: 1489509183769

},
“15acdaacc6c1681fa2fbc1dc397”: {

“name”: “City”,
“entity”: false,
“ts”: 1489509207148

},
“15acdaafe5ebcb9394b4b9a6068”: {

“name”: “State”,
“entity”: false,
“ts”: 1489509219934

},
“15acdae691c3690bea47703e1cb”: {

“name”: “SSN”,
“entity”: false,
“ts”: 1489509443868

}

}

The following is an example of a JSON encoded entity graph:

{ //Keys are entity IDs, values are entities

“0”: { //ID 0 is the default root entity

/*Each key in entity is an attribute ID (see defined attributes above), each value is
either a string literal or an entity ID */
“15acdaa364ecb5c564743266fd3”: “15ace8a23dc3579ff46f24645d5”,
“15acdadca13c51b1badb39a28bf”: “15ace8aa4b4b3fe1e5937b60233”,
“15acdae1d72801cb3ee6bfbeff0”: “15ace8b756136ebc6677c192f0”,
“15acdab622c2b872ac8bf50b0b7”: “15ace8aa4b4b3fe1e5937b60233”,
“15acdabc5635dda383f10ad82fc”: “15ace8c50c48f0bdd5880e53136”,
“15acdabf02ba8e1787398c8261c”: “15ace8c636e69740c40f985acc9”,
“15a0fbcbe88ac1f4896f15a8c37”: “1232”,
“ts”: 1489524083945 //Timestamp of most recent changes

},
“15ace8a23dc3579ff46f24645d5”: {

“id”: “15ace8a23dc3579ff46f24645d5”,
“name”: “Satchel E Spencer ”,
“ts”: 1489523922344,
“15acdaa71196c89c41741fa987”: “Ellsasjkha”,
“15acdaacc6c1681fa2fbc1dc397”: “Boulder”,
“15acdaafe5ebcb9394b4b9a6068”: “Colorado”,
“15acdae691c3690bea47703e1cb”: “2233445”

},
“15ace8aa4b4b3fe1e5937b60233”: {

“id”: “15ace8aa4b4b3fe1e5937b60233”,
“name”: “David A. Perlick”,
“ts”: 1489523956307

},
“15ace8b756136ebc6677c192f0”: {

“id”: “15ace8b756136ebc6677c192f0”,
“name”: “Hunter A. Trujillo”,
“ts”: 1489524010941

},
“15ace8c50c48f0bdd5880e53136”: {

“id”: “15ace8c50c48f0bdd5880e53136”,
“name”: “James”,
“ts”: 1489523986628

},
“15ace8c636e69740c40f985acc9”: {

“id”: “15ace8c636e69740c40f985acc9”,
“name”: “Hats”,
“ts”: 1489524002790

}

}

Based upon the disclosure provided herein, one of skill in the art will recognize a variety of metadata formats and data encodings that can be used to store structured data for a document automation system in relation to different embodiments of the present developments.

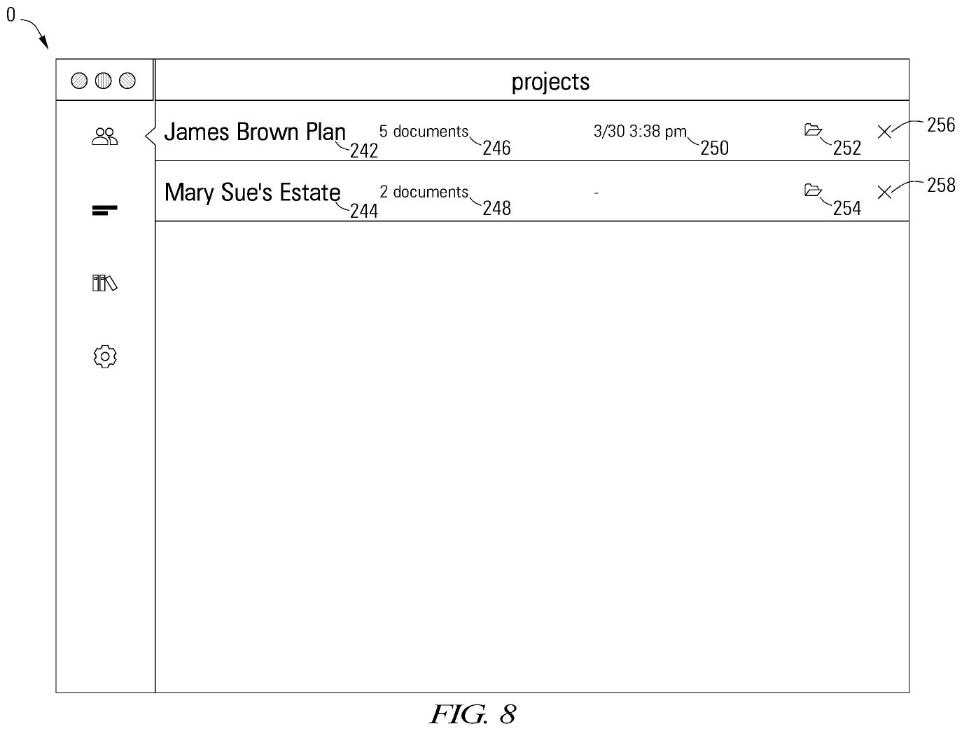

Turning now to FIG. 8, a screenshot depicts a document automation application identifying projects being maintained in accordance with one or more embodiments. In this example, a projects window 240 shows two existing projects 242, 244, the first including five documents 246 and the second including two documents 248. The projects window 240 can include an identification 250 of the date and time of creation or modification, and buttons 252, 254 to open file and/or folder selectors to list the documents in the projects or to add or remove documents to or from the project. ‘X’s 256, 258 can be used to “unwatch” a project when it is no longer in use.

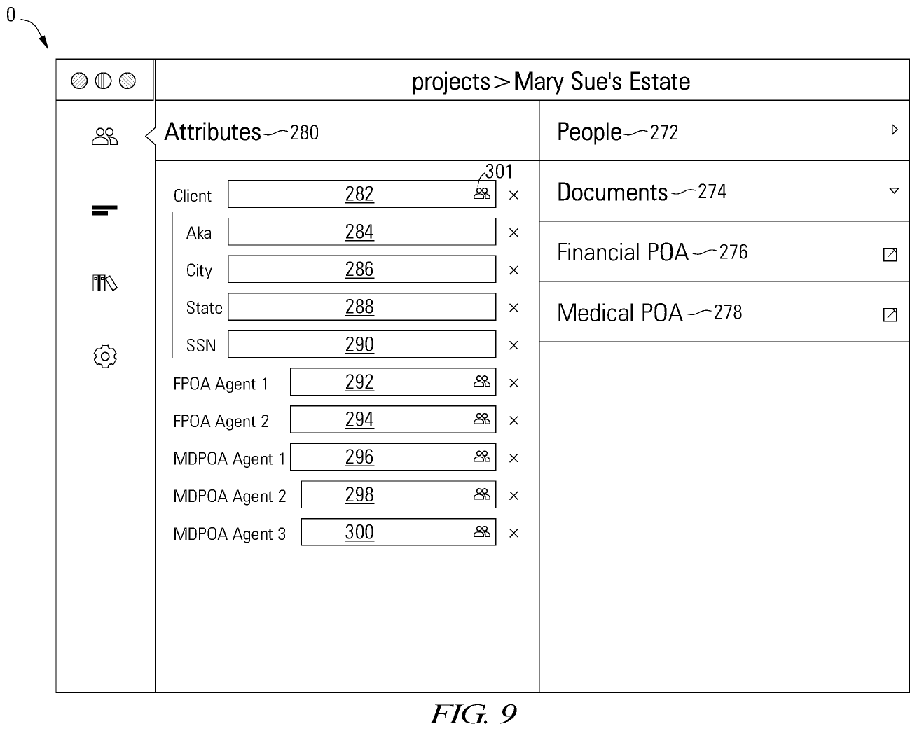

Turning to FIG. 9, a screenshot depicts a single project being maintained by a document automation system before data is entered in accordance with one or more embodiments. A project data entry window 270 includes a people menu 272 that enables a user to enter information about people to be populated into documents in the project. In some cases, each person in the project is associated with an entity in the project. A documents menu 274 enables the user to select documents (e.g., 276, 278) to be included in the project. An attributes input 280 enables a user to enter values for the project, some of which contain strings and some of which contain references to entities (people) in the project. For example, an entry box 282 enables a user to enter a value for a client attribute, which would contain a reference to an entity specifying a person in the project, either by entering data about a new person or selecting an existing person entry. Entry boxes 284, 286, 288, 290 enable a user to enter strings associated with the client attribute in the entry box 282 above. Entry boxes 292, 294, 296, 298, 300 enable a user to enter references to other entities related to the entity of the client attribute specified in entry box 282, in this case agents for financial and medical powers of attorney. The presence of an indicator (e.g., 301) in each entry box can be used to indicate that the value will contain a reference to another entity, or, if not present, that the value will contain a string to be populated into a field location in a document. By creating attributes and entities, then setting the relationships between entities using values that contain references to entities, accessors are created to navigate the entity graph to retrieve and update values to be populated in field locations in the documents 274. By storing all of this structured data in metadata in the documents 274 themselves, the documents can be processed in any manner while retaining the connection to their state, including updating, saving, transmitting, applying version control, etc.

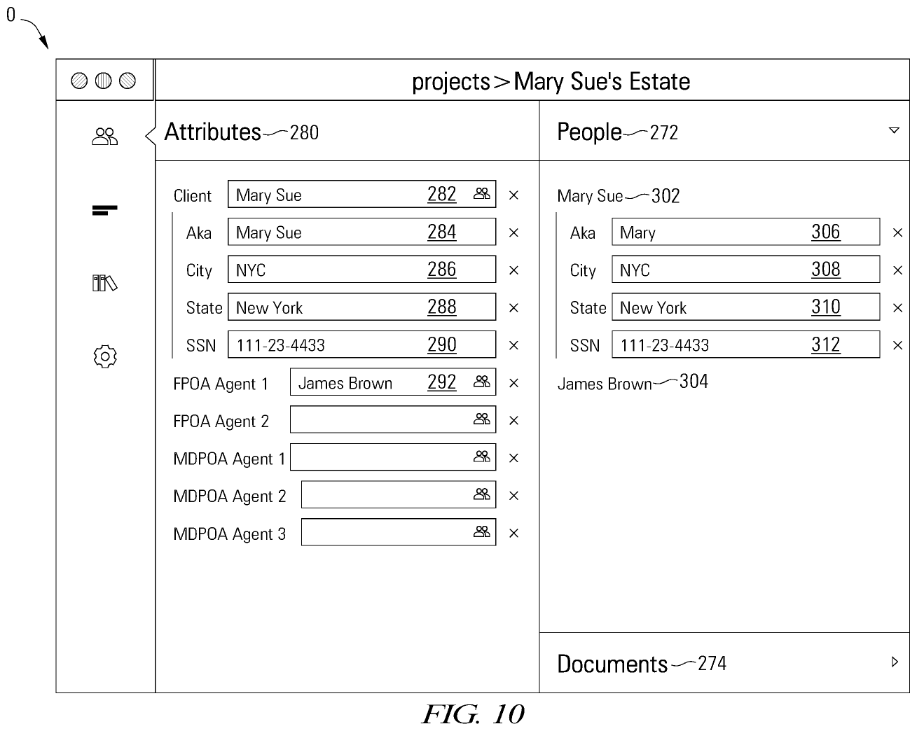

Turning to FIG. 10, a screenshot depicts the project data entry window 270 with data entered into some of the attributes. Two people (entities) 302, 304 have been entered, along with static values 306, 308, 310, 312 for the first person 302. The attributes menu 280 displays the string (e.g., 284, 286, 288, 290) and reference attributes (e.g., 282, 292) for the selected person or entity 302. In this example, to populate the name of the client into a project document, an accessor [client, name] would be used that begins with the root entity, specifies the client attribute in the root entity which would reference the client entity, and specifies the name attribute in the client entity, which would contain the name “Mary Sue”. To populate the name of the client's financial power of attorney agent, an accessor [client, FPOA Agent 1, name] would be used that begins with the root entity, specifies the client attribute in the root entity which would reference the client entity, specifies the FPOA Agent 1 attribute which would reference the FPOA Agent 1 entity, and specifies the name attribute in the FPOA Agent 1 entity, which would contain the name “James Brown”. If the reference to the FPOA Agent 1 entity were changed in entry box 292 in any of the documents in the project, or were changed directly in the metadata of a closed file in the project, this change would be synchronized in all documents in the project by the document automation application, including all the entity graphs and accessors affected by the change.

Again, the type of document, in this case a text document, and the type of structured data being populated into field locations in the document, in this case text strings, is merely an example of one embodiment of the document automation system. The document automation system can be configured to manage any type of structured data in any type of document, such as, but not limited to, text in a text document, cell values or other data in a spreadsheet, computer executable code to be inserted in the source code for a computer program, data or HTML codes to be inserted in an HTML document, images or portions of images to be inserted into an image file, videos or video clips or video sequences to be inserted in a video file, audio clips to be inserted into an audio or video file, etc. Any type of document editor suitable for editing the document can be used, whether a local application, web application or other. In some embodiments, the structured data is stored as metadata inside the documents themselves, so the structured data and database remain with the documents.

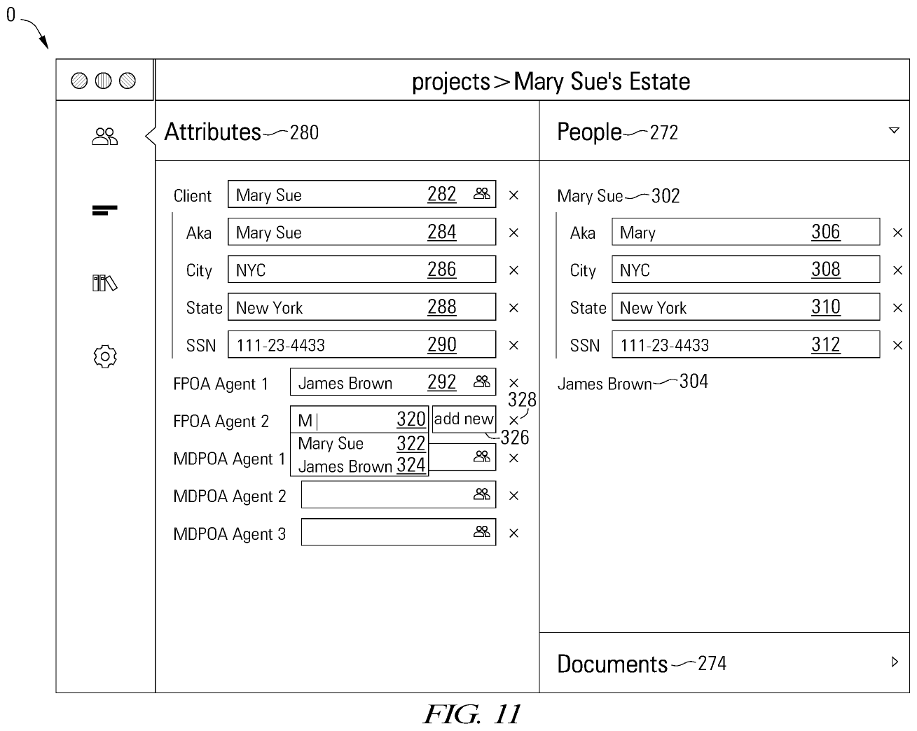

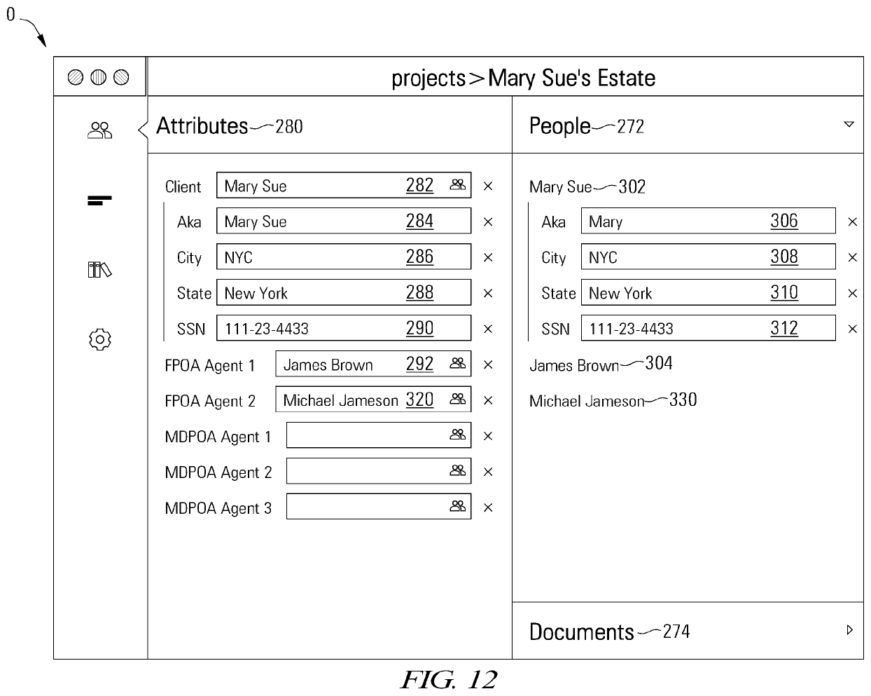

Turning to FIG. 11, a screenshot depicts the project data entry window 270 in a document automation system as a new entity is entered, with autocomplete providing access to data from existing entities in accordance with one or more embodiments. As information is typed into an entry box 320 for the second financial power of attorney agent attribute of the client entity, in some embodiments a list will appear containing the existing entities 322, 324 in the project, using autocomplete to simplify the selection of an existing entity (e.g., 322). Entering a reference to another entity in the entry box 320 for the second financial power of attorney agent attribute of the client entity (or, in general, entering any data in the document automation system which references existing data) can thus be simplified using autocomplete. An “add new” button can also be provided to enable the user to easily create a new entity in place, and a clear or delete button 328 can be provided to clear or delete the attribute 320. For example, the project data entry window 270 is depicted in FIG. 12 with a new person (entity) having been entered and referenced in the entry box 320 for the second financial power of attorney agent attribute of the client entity, and also included as an entry 330 in the list of people in the project.

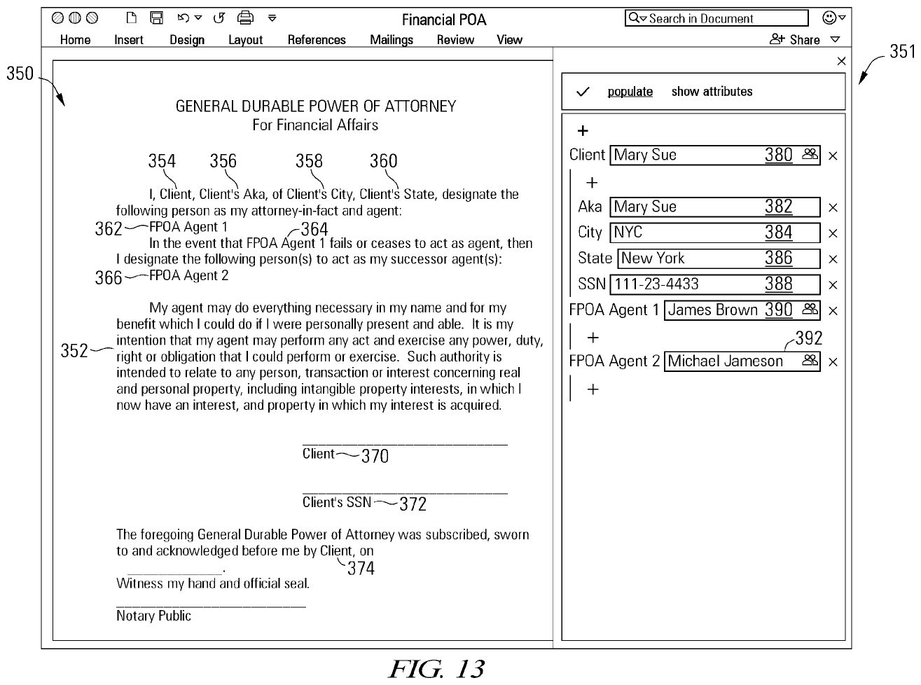

Turning to FIG. 13, a screenshot of a document in a word processor is depicted with field locations to be populated by a document automation system in accordance with one or more embodiments. In this example, the document editing window 350 is placed alongside the user interface 351 of the plugin. The document editing window 350 displays the document, including both unstructured data 352 (static text) and field locations client 354, client's AKA 356, client's city 358, client's state 360, FPOA Agent 1 362, FPOA Agent 1 364, FPOA Agent 2 366, client 370, client's SSN 372, and client 374. Notably, values can be used in multiple places in a single document and in multiple documents of a project and are kept synchronized by the document automation system. For example, the name of the client appears in the document in three field locations 354, 370, 374, and a change to the value in any of the locations or in the plugin user interface 351 will be updated in all the field locations (e.g., 354, 370, 374) of the document as well as in any field locations in other documents in the project corresponding to the attribute.

The plugin user interface 351 enables a user to define and update entities and attributes, as well as to define the accessors to a value by setting attributes of one entity to reference other entities. The example plugin user interface 351 is displaying a client entity which includes a client attribute 380 that is set to reference a Mary Sue entity. The Mary Sue entity includes static value attributes including an “also known as” or AKA attribute 382, set to Mary, a city attribute 384 set to NYC, a state attribute 386 set to New York, and a SSN attribute 388 set to 111-23-4433. The client entity also includes a FPOA Agent 1 attribute 390 that is set to reference a James Brown entity, and a FPOA Agent 2 attribute 392 that is set to reference a Michael Jameson entity.

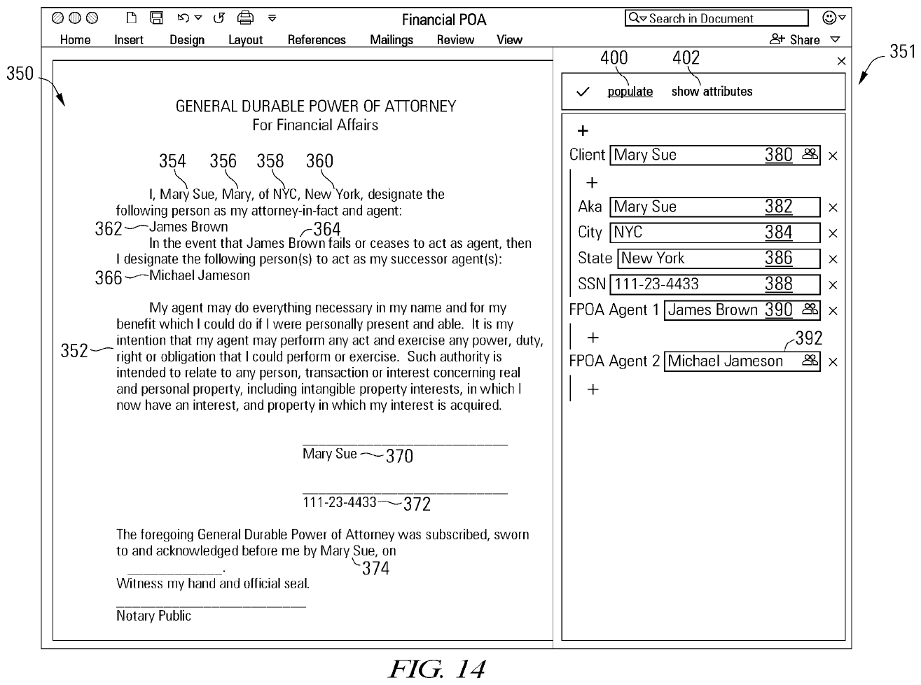

Turning to FIG. 14, a screenshot of the document editing window 350 and plugin user interface 351 is depicted with field locations populated by a document automation system in accordance with one or more embodiments. A pair of selectors 400, 402 or buttons is provided in the plugin user interface 351 which enables a user to select whether the field locations 354, 356, 358, 360, 362, 364, 366, 370, 372, 374 display the attribute identifiers as in FIG. 13 by clicking the “show attributes” selector 402, or values as in FIG. 14 by clicking the “populate” selector 400. Notably, populating the field locations with values as in FIG. 14 does not statically merge the values into the text of the document, which would break the link between the database and the document. Rather, the field locations remain in the document with either the attribute identifiers or the values displayed, maintaining the link between the document and the database. This allows both the document or template and the database to be edited concurrently.

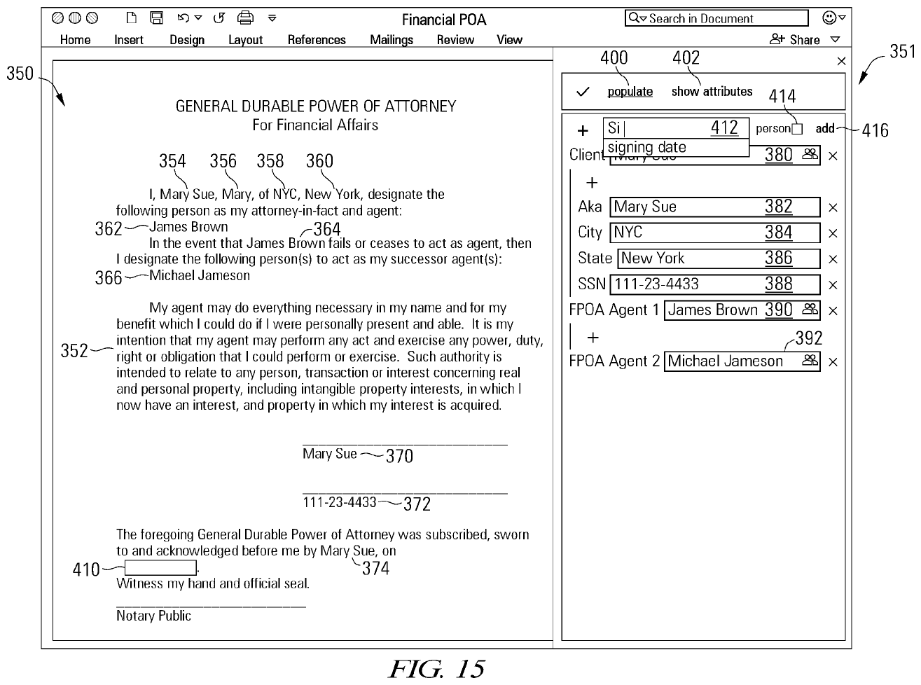

Turning to FIG. 15, a screenshot of the document editing window 350 and plugin user interface 351 is depicted as a signing date attribute is entered in an attribute entry box 412 is added to the document at field location 410. If the attribute being added has been used in the project previously, the previously added attribute may be selected in an autocomplete suggestion dropdown menu. A checkbox or other selector 414 enables the user to indicate whether the new attribute contains a static value or a reference to another entity (person). When the new attribute has been entered in the attribute entry box 412, an add button 416 can be clicked to save the entry and apply the change.

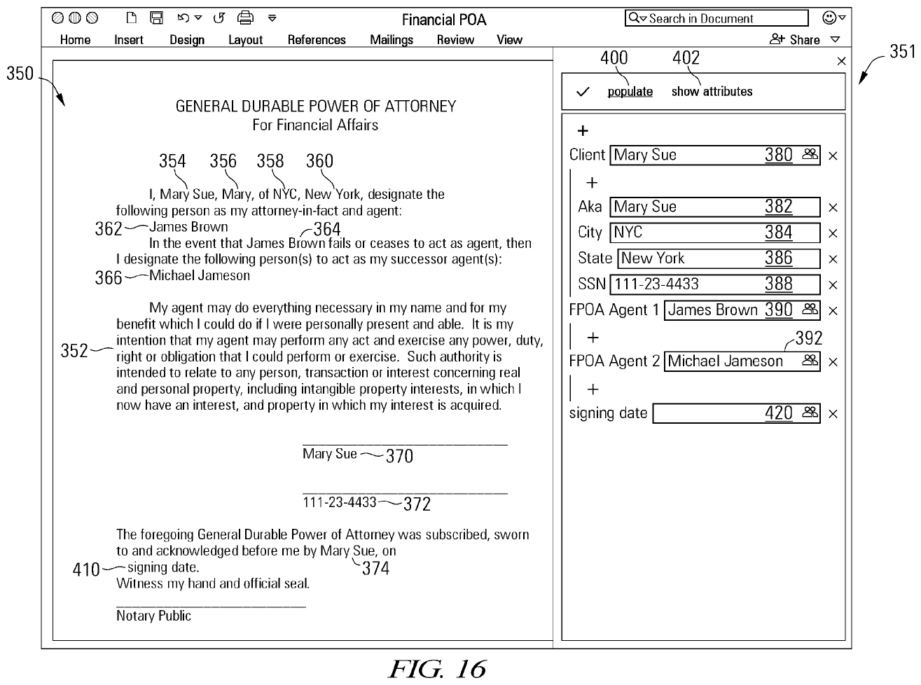

Turning to FIG. 16, a screenshot of the document editing window 350 and plugin user interface 351 is depicted with the new signing date attribute in field location 410, and with the new attribute 420 listed in the client entity in the plugin user interface 351. With the plugin user interface 351 in the populate mode (with the populate selector 400 selected), the signing date will be populated and displayed in field location 410 once a date has been entered in the signing date attribute entry box 420.

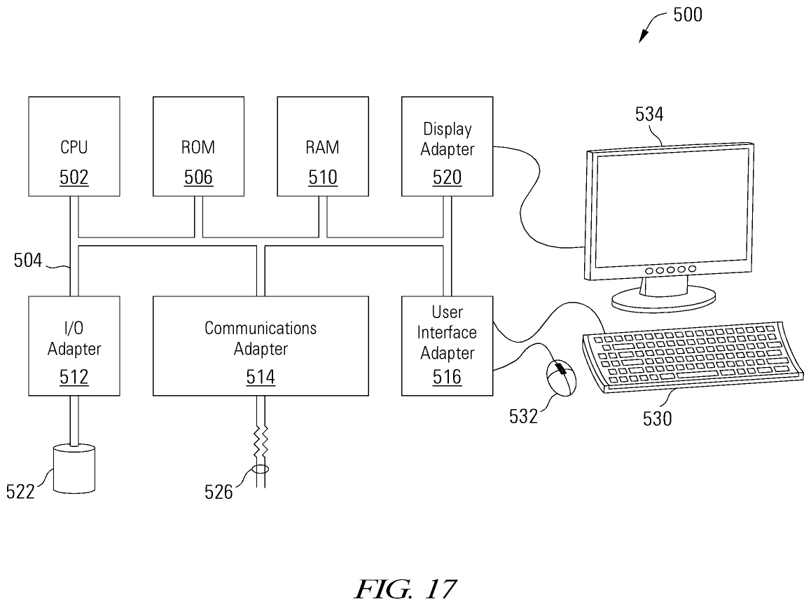

Turning to FIG. 17, a computer system 500 is depicted that may be used in systems and methods for document automation in accordance with some embodiments. The computer system 500 may be used, for example, to store and access data in a document metadata filesystem database in which structured data is stored in or alongside the documents, to support concurrent editing of the structured data alongside unstructured data (e.g., document text), and to support graph-like access of data in the document metadata filesystem database.

The computer system 500 generally includes one or more central processing units (CPU) 502 connected by a system bus 504 to devices such as a read-only memory (ROM) 506, a random access memory (RAM) 510, an input/output (I/O) adapter 512, a communications adapter 514, a user interface adapter 516, and a display adapter 520. Data storage devices such as a hard drive 522 are connected to the computer system 500 through the I/O adapter 512. In operation, the CPU 502 in the computer system 500 executes instructions stored in binary format on the ROM 506, on the hard drive 522, and in the RAM 510, causing it to manipulate data stored in the RAM 510 to perform useful functions including the document automation as disclosed herein. The computer system 500 may communicate with other electronic devices through local or wide area networks (e.g., 526) connected to the communications adapter 514. User input is obtained through input devices such as a keyboard 530 and a pointing device 532 which are connected to the computer system 500 through the user interface adapter 516. Output is displayed on a display device such as a monitor 534 connected to the display adapter 520.

The document automation disclosed herein is applicable to virtually any type of document, including but not limited to those with integral metadata, such as, for example, text files, word processing documents (whether stored as plain text, in a word processing format, or encoded in any manner), HTML documents, image files, computer executable source code, audio, video, etc.

In conclusion, novel systems and methods for document automation have been provided. While detailed descriptions of one or more embodiments have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A method for document automation where the structured data that determines the content of the document(s) is stored within the metadata of the document(s), the method comprising:
for at least one document comprising at least one field location, obtaining at least one value to be populated into at least one of the at least one field locations in the at least one document;
defining at least one attribute comprising a name and a unique identifier, wherein each said at least one value is associated with one of said at least one attributes;
storing the at least one value and its associated attribute definition in metadata associated with the at least one document; and
populating the at least one field location in the at least one document with associated values from the metadata.

2. The method of claim 1, wherein the at least one document comprises a plurality of documents, each comprising at least one of the at least one field locations, wherein the storing comprises, for each of the plurality of documents, storing the at least one value to be populated in at least one of the at least one field locations in that document, along with the attribute definitions associated with the at least one value to be populated in that document, in that document's own metadata.

3. The method of claim 2, further comprising synchronizing the at least one value stored in the metadata of the plurality of documents to a consistent state.

4. The method of claim 1, further comprising defining a plurality of entities, wherein each of the entities comprises a unique entity identifier and a grouping of at least one of the attributes and the value associated with each such attribute, and wherein each such associated value in each entity comprises a static value to be populated into the at least one field locations in the at least one document or a reference to another of the entities.

5. The method of claim 4, further comprising accessing a particular value of the values associated with the plurality of entities, by traversing a list of attributes from a root entity in the plurality of entities, wherein the value associated with each of the attributes in the list of attributes except a last attribute in the list of attributes is a reference to another of the entities, and the value associated with the last attribute in the list of attributes comprises the static value to be populated into the at least one field location of the at least one document.

6. The method of claim 5, wherein the traversing comprises:
setting a current entity as the root entity;
while the list of attributes contains more than one attribute:
popping an attribute from the list of attributes;
retrieving the value of the popped attribute from the current entity; and
setting the current entity as the entity referenced by the value; and
when the list of attributes contains one attribute:
popping the one attribute from the list of attributes; and
retrieving the value as the data to be populated into the at least one document at the at least one field location.

7. The method of claim 1, wherein each of the at least one field locations is defined in terms of a list of attributes.

8. An apparatus for automating document preparation, the apparatus comprising:
a non-transitory storage device having tangibly embodied therein instructions representing computer executable program code for automating document preparation; and
one or more processors coupled to the non-transitory storage device and operable to execute the computer executable program code for automating document preparation to perform a method comprising:
monitoring for changes to values in at least one field location in a document;
when a change to a value is detected in the document, updating all field locations in the document having values based on the changed value, wherein field locations are updated without converting them to static content; and
saving the document together with the values, such that changes to both static content in the document and changes to the values are saved concurrently.

9. The apparatus of claim 8, wherein the method further comprises synchronizing changes to the values across multiple documents comprising a project.

10. The apparatus of claim 9, wherein updating field locations in the document based on the changed value comprises commanding a document editor to edit the field locations associated with the values.

11. The apparatus of claim 8, wherein the values are saved as metadata in the document.

12. The apparatus of claim 9, wherein updating values across the multiple documents in a project comprises editing saved files for the documents which are not open in a document editor.

13. A document automation system, comprising:
a user interface configured to accept a plurality of values to be populated into field locations in a document; and
a state change manager configured to determine a document state of the document, the document state comprising information about the plurality of values and their associated field locations, and about an entity graph comprising at least one entity, the at least one entity comprising at least one attribute associated with one of the plurality of values, the state change manager further being configured to identify changes to the document state based on changes to at least one of the plurality of values, wherein the state change manager is further configured to, based upon a change to one of the plurality of values, update others of the plurality of values which are related to the changed value.

14. The document automation system of claim 13, wherein the user interface and the state change manager comprise a plugin to a document editor.

15. The document automation system of claim 13, further comprising a document automation application, the document automation application comprising a state synchronization backend configured to receive state changes from each document in a project, and to generate a global state for the project based upon the state changes.

16. The document automation system of claim 15, wherein the state synchronization backend is configured to propagate changes to affected ones of the plurality of values in all the documents in the project based upon the state changes from the plugins, from closed documents through a filesystem, and from the document automation application.

17. The document automation system of claim 15, wherein the state changes comprise timestamps, and wherein the state synchronization backend is configured to resolve conflicting state changes by comparison of the timestamps.

18. The document automation system of claim 15, wherein the state synchronization backend is configured to monitor a filesystem for state changes in closed documents in the project, and to propagate changes to affected ones of the plurality of values in all the documents in the project based upon the state changes in the closed documents, the state synchronization backend further being configured to write changes to affected ones of the plurality of values in the closed documents based upon the state changes from the plugins, from closed documents through the filesystem, and from the document automation application.

19. The document automation system of claim 15, wherein the plugins are configured to populate and update the plurality of values in the documents of the project so values are displayed in the documents, without being converted to static content in the documents, wherein the values, and static content other than field locations, can be edited and saved concurrently.

20. The document automation system of claim 13, wherein the plurality of attributes, field locations, and entity graph are stored in metadata of the document.

21. The document automation system of claim 15, wherein the state synchronization backend is configured to access values by traversing the entity graph from a root entity along references between entities in the entity graph, wherein the references between entities are specified in values of attributes in the entities, and wherein the list of attributes containing the references between entities are specified in an accessor.
